(19) United States
(12) Patent Application Publication
(10) Pub. No.: US 2024/0322459 A1
(43) Pub. Date: Sep. 26, 2024

(54) CONDUCTOR TERMINAL

(71) Applicant: WAGO Verwaltungsgesellschaft mbH, Minden (DE)

(72) Inventors: Henry STOLZE, Bad Frankenhausen (DE); Daniel LANGE, Bueckeburg (DE); Johannes GIESE, Raddestorf (DE)

(73) Assignee: WAGO Verwaltungsgesellschaft mbH, Minden (DE)

(21) Appl. No.: 18/735,150

(22) Filed: Jun. 5, 2024

Related U.S. Application Data
(63) Continuation of application No. PCT/EP2022/084595, filed on Dec. 6, 2022.

(30) Foreign Application Priority Data
Dec. 6, 2021 (DE) 10 2021 132 043.7

(51) Int. Cl. H01R 4/48; H01R 9/22

(52) U.S. Cl. CPC H01R 4/48365; H01R 9/223

(57) ABSTRACT

A conductor terminal including a casing made of insulating material. A first spring-loaded clamping connection has a first conductor-receiving space for receiving a first electrical conductor. A second spring-loaded clamping connection has a second conductor-receiving space for receiving a second electrical conductor. The first spring-loaded clamping connection is connected to the second spring-loaded clamping connection via a busbar extending from the first conductor-receiving space to the second conductor-receiving space. The casing made of insulating material comprises multiple parts including a main casing part and at least a first cover part.

This nonprovisional application is a continuation of International Application No. PCT/EP2022/084595, which was filed on Dec. 6, 2022, and which claims priority to German Patent Application No. 10 2021 132 043.7, which was filed in Germany on Dec. 6, 2021, and which are both herein incorporated by reference.

### BACKGROUND OF THE INVENTION

### Field of the Invention

The invention relates to a conductor terminal with a casing made of insulating material, a first spring-loaded clamping connection, and a first conductor-receiving space, associated with the first spring-loaded clamping connection, for receiving a first electrical conductor to be clamped to the first spring-loaded clamping connection, as well as a second spring-loaded clamping connection and a second conductor-receiving space, associated with the second spring-loaded clamping connection, for receiving a second electrical conductor to be clamped to the second spring-loaded clamping connection, wherein the first spring-loaded clamping connection is connected to the second spring-loaded clamping connection via a busbar extending from the first conductor-receiving space to the second conductor-receiving space, wherein the casing made of insulating material is formed in multiple parts with a main casing part and at least one first cover part.

### Description of the Background Art

A generic conductor terminal is known from DE 10 2019 108 291 A1, which corresponds to US 2022/0013929, which is incorporated herein by reference.

### SUMMARY OF THE INVENTION

It is an object of the invention to provide a further improved conductor terminal.

This object is achieved in a conductor terminal in that the first cover part only extends over the height section of the second spring-loaded clamping connection in a height direction of the conductor terminal in which the first spring-loaded clamping connection is arranged above the second spring-loaded clamping connection. In this way, the invention enables a relatively simple and cost-effective construction of the conductor terminal using already proven components and design principles. Advantageously, a simple and automated assembly of the conductor terminal is possible. This is promoted in particular by the advantageous design of the first cover part, which is relatively small and only extends over a comparatively small height region of the conductor terminal. The height direction H of the conductor terminal in this case extends perpendicular to the conductor insertion direction of the first spring-loaded clamping connection and/or perpendicular to the conductor insertion direction of the second spring-loaded clamping connection.

The first spring-loaded clamping connection and the first conductor-receiving space can be arranged in the casing made of insulating material, wherein the first spring-loaded clamping connection can be arranged at least partially in the first conductor-receiving space. In an example, the second spring-loaded clamping connection and the second conductor-receiving space are arranged in the casing made of insulating material, wherein the second spring-loaded clamping connection can be arranged at least partially in the second conductor-receiving space.

At least one section of the first cover part can form a partition wall between the first and second conductor-receiving space. The first conductor-receiving space is thus separated from the second conductor-receiving space by the first cover part. In this way, the main casing part can be designed with a relatively large opening, at least on the side on which the first cover part is to be inserted into it, so that simple automated assembly of the components in the main casing part, in particular the components of the second spring-loaded clamping connection, is possible. In addition, material is saved and assembly is simplified compared to the conductor terminal known from the state of the art.

The first spring-loaded clamping connection can have a first clamping spring. The first clamping spring can have a first clamping leg for clamping the first electrical conductor to a first clamping point, arranged in the casing made of insulating material, and a first contact leg, by means of which the first clamping spring is supported against the clamping force of the first clamping leg. This enables reliable clamping of the first electrical conductor by means of spring force. The first clamping spring can have at the free end of the first clamping leg a clamping edge, by which the first electrical conductor can be clamped particularly securely at the first clamping point. The first clamping spring can have a first spring bend, via which the first clamping leg is connected to the first contact leg.

The second spring-loaded clamping connection can have a second clamping spring. The second clamping spring can have a second clamping leg for clamping the second electrical conductor to a second clamping point, arranged in the casing made of insulating material, and a second contact leg, by means of which the second clamping spring is supported against the clamping force of the second clamping leg. This enables reliable clamping of the second electrical conductor by means of spring force. The second clamping leg can have at the free end a clamping edge, by which the second electrical conductor can be clamped particularly securely at the second clamping point. The second clamping spring can have a second spring bend, via which the second clamping leg is connected to the second contact leg.

The first spring-loaded clamping connection can be formed as a direct plug-in connection, into which the first electrical conductor can be plugged directly without actuating the first clamping leg and can be clamped in this way. The second spring-loaded clamping connection can be formed as a direct plug-in connection, into which the second electrical conductor can be plugged directly without actuating the second clamping leg and can be clamped in this way.

The first cover part can be formed, for example, U-shaped in lateral cross section and thus form a receiving chamber for a second electrical conductor part that protrudes beyond the second clamping spring. The first cover part can also be designed with a cavity that is open on one side and directed toward the inside of the casing made of insulating material.

The first cover part can have a support contour, e.g., a concave curved contour, which is designed to support at least a part of the second clamping spring, e.g., to support the second spring bend of the second clamping spring. The support contour can be integrated into a side wall of the first cover part.

The casing made of insulating material can have a first conductor insertion opening for inserting the first electrical conductor into the casing made of insulating material. The casing made of insulating material can have a second conductor insertion opening for inserting the second electrical conductor into the casing made of insulating material. According to an example of the invention, it is provided that the first conductor insertion opening is arranged on the conductor terminal side facing away from the second conductor insertion opening. An advantageous connection terminal similar to a feed-through terminal block is provided in this way.

The first cover part can be arranged opposite the second conductor insertion opening. In this way, the first cover part can form the rear end, so to speak, of a second conductor insertion channel, adjoining the second conductor insertion opening, of the conductor terminal.

At least one section of the first cover part can form a partial section of a first conductor insertion channel, leading from the first conductor insertion opening to the first conductor-receiving space, of the casing made of insulating material. This has the advantage that the first cover part can take on an additional function, namely, the conductor guidance of the first electrical conductor in the first conductor-receiving space. The mentioned section of the first cover part, which can form a partial section of the first conductor insertion channel, can be, e.g., as a wall section of the first cover part suitable for guiding conductors.

The casing made of insulating material can have a second cover part at which at least one part of the first spring-loaded clamping connection is supported and/or fastened. This has the advantage that the first spring-loaded clamping connection can also be easily mounted in the casing made of insulating material, in particular by automated assembly. The components of the first spring-loaded clamping connection, in particular the first clamping spring and a busbar and/or a retaining frame and, if necessary, an actuation element and/or the second cover part can be inserted into the main casing part as a preassembled assembly.

The second cover part can be inserted into the main casing part in a direction that runs transversely to the conductor insertion direction of the first spring-loaded clamping connection. This enables simple and reliable automated assembly of the first spring-loaded clamping connection in the main casing part, especially if this assembly has an actuation element such as, e.g., an actuation lever.

The first cover part can be inserted into the main casing part in a direction that runs at least substantially parallel to the conductor insertion direction of the first spring-loaded clamping connection. Accordingly, the first cover part is inserted into the main casing part in a different direction than the second cover part. This is also advantageous for automated assembly.

The busbar can extend through an opening from the first conductor-receiving space to the second conductor-receiving space, which is formed by opposite end faces of a wall of the main casing part and of the first cover part. This has the advantage that the busbar can also be easily inserted into the casing made of insulating material. The busbar can be inserted into the main casing part, for example, as part of a preassembled unit, containing the second spring-loaded clamping connection, together with it.

The opening can be formed relatively short, e.g., with a length of less than 30% or less than 20% of the length of the conductor terminal, e.g., measured from the side of the casing made of insulating material on which the first conductor insertion opening is located to the opposite side of the casing made of insulating material.

The second spring-loaded clamping connection can be arranged on the first clamping leg side facing away from the first contact leg. In this way, a conductor terminal can be realized which is relatively short in the conductor insertion direction and in which the first spring-loaded clamping connection and the second spring-loaded clamping connection are arranged one above the other, so to speak.

The busbar can have a first clamping section which forms the first clamping point with the first clamping leg.

The busbar can have a curved section, which adjoins the first clamping section and in which the busbar merges in an arcuate manner directly or via at least one further section of the busbar into a second clamping section, which forms a second clamping point with a second clamping leg of the second clamping spring for clamping the second electrical conductor.

The second clamping section can be arranged substantially and/or predominantly parallel to the first clamping section. This is also conducive to a compact design of the conductor terminal. The busbar can have a U-shape in a side view, for example.

The connection module can have an actuation element as a further component, in particular an actuation lever or a push button, with which the first clamping leg can be deflected by manual actuation in order to open the first clamping point. This allows easy opening of the first clamping point without an additional tool. By the deflection of the clamping leg, it is moved away from the first clamping section of the busbar. The actuation lever can be formed, for example, as a pivoting actuation lever.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a conductor terminal in perspective sectional view;

FIGS. 2 and 3 show an actuation element in various perspective views;

FIG. 4 shows a first spring-loaded clamping connection in a perspective view;

FIG. 5 shows a second spring-loaded clamping connection in a perspective view;

FIG. 6 shows an assembly having the first spring-loaded clamping connection in a side sectional view;

FIG. 7 shows a first cover part in a perspective view;

FIG. 8 shows a second cover part in a perspective view; and

FIG. 9 shows the conductor terminal formed with the first cover part according to FIG. 7 and the second cover part according to FIG. 8 in a perspective view.

### DETAILED DESCRIPTION

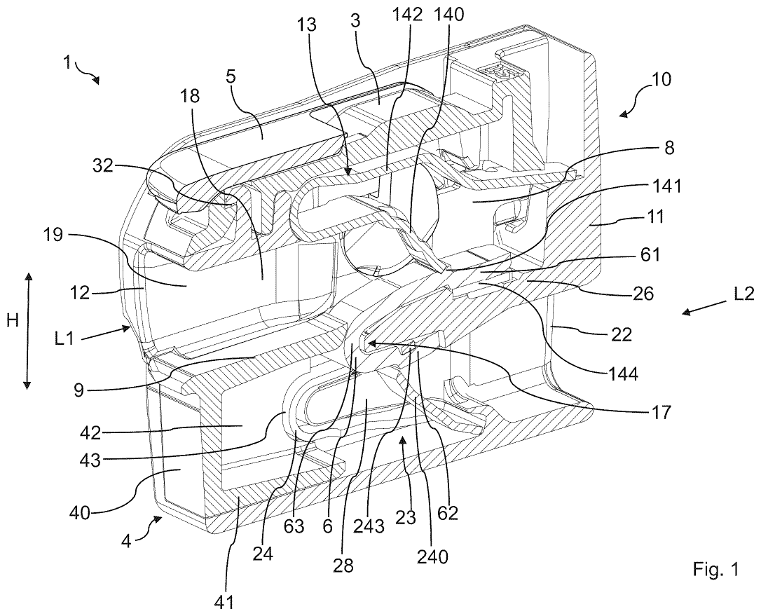

FIG. 1 shows a conductor terminal 1 with a casing made of insulating material 10, a first spring-loaded clamping connection 13 arranged therein, and a second spring-loaded clamping connection 23 also arranged therein. A first conductor-receiving space 18 for receiving a first electrical conductor is assigned to first spring-loaded clamping connection 13. A second conductor-receiving space 28 for receiving a second electrical conductor is assigned to second spring-loaded clamping connection 23. A first clamping spring 14 is arranged in first conductor-receiving space 18 and a second clamping spring 24 in second conductor-receiving space 28.

The first electrical conductor can be inserted into first conductor-receiving space 18 in a conductor insertion direction L1, and the second electrical conductor can be inserted into the second conductor-receiving space 28 in an opposite conductor insertion direction L2.

Casing made of insulating material 10 is formed of multiple parts with a main casing part 11, a first cover part 4, and a second cover part 3. First cover part 4 is formed U-shaped in the lateral cross-sectional view, with a lower wall 41, a rear wall 40 forming an outer wall of casing made of insulating material 10, and an upper wall 9. These walls 9, 40, 41 form the U-shape of first cover part 4 in the lateral sectional view. First cover part 4 can additionally have on one or both sides side walls 42 by which, together with walls 9, 40, 41, a cavity closed on four or five sides is provided for receiving an electrical conductor. A support contour 43 can be formed in one or both side walls 42 to support second clamping spring 24. If first cover part 4 is attached to main casing part 11, rear wall 40, for example, can form an outer wall of casing made of insulating material 10. Lower wall 41 can then be arranged substantially completely overlapping with an outer wall of main casing part 11. Upper wall 9 can then form a partition wall between the first and second conductor-receiving space 18, 28 and/or form a partial section of a first conductor insertion channel 19 of casing made of insulating material 10, said channel leading to first conductor-receiving space 18.

First spring-loaded clamping connection 13 has a first clamping spring 14. First clamping spring 14 has a first clamping leg 140, for clamping a first electrical conductor at a first clamping point 141, and a first contact leg 142. First clamping spring 14 is supported against the clamping force of first clamping leg 140 by first contact leg 142. For this purpose, first contact leg 142 is suspended in a holding frame 8. Holding frame 8 extends from an upper area of first contact leg 142 to a lower busbar support area 144, on which a busbar 6 rests.

Busbar 6 has a first clamping section 61, a curved section 63 which adjoins first clamping section 61 and in which busbar 6 is formed curved and merges into a second clamping section 62 of busbar 6. Clamping leg 140 is supported via busbar 6 or via its first clamping section 61 on busbar support area 144, or indirectly via the first electrical conductor when the first electrical conductor is clamped there.

It can be seen that busbar 6 extends from first clamping point 141 through an opening 17 to second clamping point 241. Opening 17 is formed by mutually facing end faces of upper wall 9 of first cover part 4 and a wall 26 of main casing part 11.

Casing made of insulating material 10 has a first conductor insertion opening 12, through which the first electrical conductor can be inserted into casing made of insulating material 10 to first clamping point 141. Finally, a first conductor receiving channel 19 adjoins conductor insertion opening 12. Upper wall 9 of first cover part 4 forms a partial area of first conductor receiving channel 19. Casing made of insulating material 10 has a second conductor insertion opening 22, through which the second electrical conductor can be inserted into casing made of insulating material 10 to second clamping point 241. Further, a pivotable actuation lever is provided as actuation element 5 for actuating first clamping leg 140, which lever can be manually actuated on the outside of casing made of insulating material 10, e.g., on the housing side shown above, on which cover part 3 is located.

Second spring-loaded clamping connection 23 is arranged in casing made of insulating material 10 and has a second clamping spring 24 for clamping a second electrical conductor by means of spring force at a second clamping point 241. Second clamping spring 24 has a second clamping leg 240, which forms second clamping point 241 with a second clamping section 62 of busbar 6. Further, second clamping spring 24 has a second contact leg 242, which is suspended on the side, facing away from second clamping leg 240, of second clamping section 62 of busbar 6.

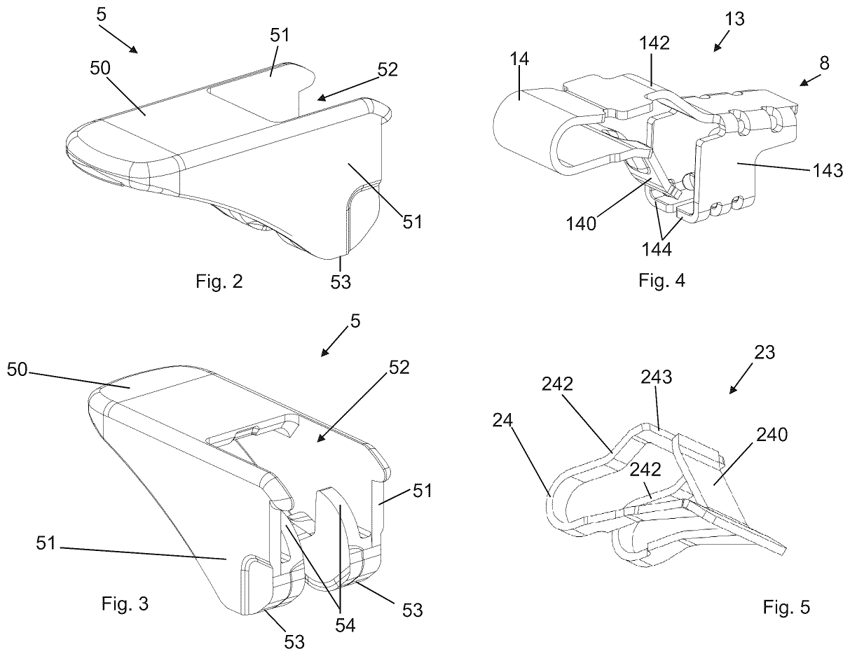

An advantageous design of actuation element 5 is explained with reference to FIGS. 2 and 3. Actuation element 5 can have a manual actuation area 50 at which it can be gripped and manually operated by the user. Actuation element 5 has two guide walls 51 which project substantially at a right angle from manual actuation area 50 and are arranged predominantly parallel to one another and between which a free space 52 is formed. For example, manual actuation area 50 can extend only over a partial section of the longitudinal extent of guide walls 51, so that in a rear area free space 52 extends up to the upper edge, facing manual actuation area 50, of guide walls 51.

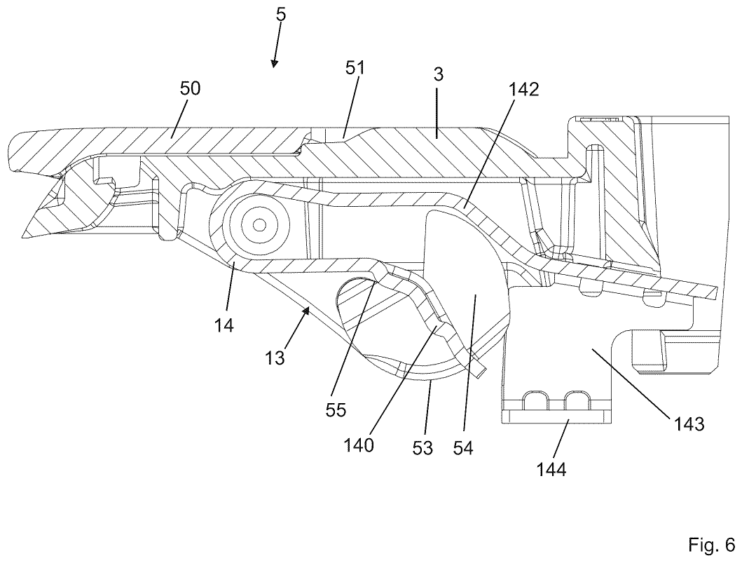

At the end facing away from manual actuation section 50, guide walls 51 have respective support regions 53, which can be formed convex in shape, e.g., at least partially arcuate in shape. Additional inner walls 54 can extend from support regions 53 parallel to the respective guide wall. In this way, an additional receiving space is created on each side of actuation element 5 between guide wall 51 and the associated inner wall 54, which can be used, e.g., to receive an inner housing wall of first casing made of insulating material 10. A spring driver 55 can be formed on one or both inner walls 54, by means of which first clamping leg 140 is deflected during a pivoting movement of actuation element 5 (visible in FIG. 6).

FIG. 4 shows the design of first clamping spring 14. Here, first clamping spring 14 is formed integrally with retaining frame 8, e.g., in that contact leg 142 is reshaped into such a retaining frame 8 via an elongated region that is bent on both sides towards first clamping leg 140. Busbar holding section 144 is connected in each case to first contact leg 142 on both sides via vertical walls 143 of retaining frame 8. In this example, retaining frame 8 is formed circumferentially closed except for a gap between lateral sections of busbar holding section 144.

FIG. 5 shows an advantageous design of second spring-loaded clamping connection 23 with second clamping spring 24. Second clamping spring 24 can be formed as a so-called push wire connection, e.g., from a sheet metal part, from which second clamping leg 240 is formed by a stamping-bending process, and second contact leg 242 is formed in the form of material sections which project to the left and right from second clamping leg 240 and are connected to each other by a transverse web 243. Transverse web 243 is used to attach second clamping spring 24 to second clamping section 62 of busbar 6, as illustrated in FIG. 1. Second contact leg 242 here forms a U-shape in a side view, wherein two sections of contact leg 242 are connected to each other via an arc. The contact leg is formed here by two web-like sections which are formed laterally on both sides of clamping leg 240 and are connected to each other at the end, facing away from clamping leg 240, via transverse web 243. An opening is formed between the web-like sections.

FIG. 6 shows a preassembled assembly formed of a first spring-loaded clamping connection 13, first cover part 3, and actuation element 5. These components are positively coupled to each other and thus hold together to form a unit, which can then be easily mounted in first main casing part 11. First clamping spring 14 is formed according to FIG. 4.

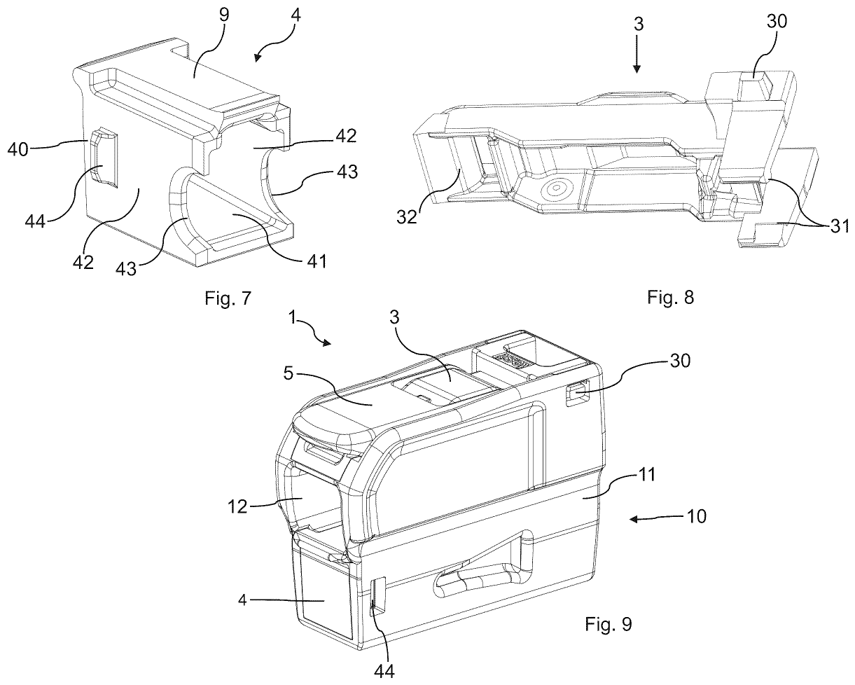

FIG. 7 shows first cover part 4 in a perspective view. The chamber-like structure with an inner cavity closed by five walls 9, 40, 41, 42 can be seen. First cover part 4 can have one or more latching elements 44, e.g., on one or more side walls 42. First cover part 4 can be latched to main casing part 11 by means of latching elements 44.

It can be seen that upper side wall 9 of first cover part 4 forms a partition wall between the first and second conductor-receiving space 18, 28. In this case, upper wall 9 simultaneously forms a partial section of a first conductor-receiving channel 19 of casing made of insulating material 10, said channel leading to first conductor-receiving space 18.

FIG. 8 shows second cover part 3 in a perspective view. To fix second cover part 3 in place, it can have, e.g., laterally projecting latching elements 30, which can be latched to main casing part 11. In addition, downwardly projecting latching tabs 31 can be provided, on which a part of first spring-loaded clamping connection 13 can be latched, e.g., the aforementioned retaining frame 8 or first clamping spring 14. On the side facing first conductor insertion opening 12, second cover part 3 has a further latching edge 32 for latching with main casing part 11, as also illustrated in FIG. 1.

FIG. 9 shows conductor terminal 1 with fully assembled housing parts. First cover part 4 is inserted into main casing part 11 parallel to conductor insertion direction L1 and latched to it by means of its latching elements 44. Second cover part 3 is inserted into main casing part 11 from above, i.e., at right angles to first conductor insertion direction L1, and is latched to it with its latching elements 30.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A conductor terminal comprising:
a busbar;
a casing made of insulating material;
a first spring-loaded clamping connection;
a first conductor-receiving space associated with the first spring-loaded clamping connection to receive a first electrical conductor to be clamped to the first spring-loaded clamping connection;
a second spring-loaded clamping connection; and
a second conductor-receiving space associated with the second spring-loaded clamping connection to receive a second electrical conductor to be clamped to the second spring-loaded clamping connection,
wherein the first spring-loaded clamping connection is connected to the second spring-loaded clamping connection via the busbar extending from the first conductor-receiving space to the second conductor-receiving space,
wherein the casing is formed in multiple parts with a main casing part and at least one first cover part, the first cover part only extending over a height section of the second spring-loaded clamping connection in a height direction of the conductor terminal in which the first spring-loaded clamping connection is arranged above the second spring-loaded clamping connection.

2. The conductor terminal according to claim 1, wherein at least one section of the first cover part forms a partition wall between the first and second conductor-receiving space.

3. The conductor terminal according to claim 1, wherein at least one section of the first cover part forms a partial section of a first conductor insertion channel leading to the first conductor-receiving space of the casing made of insulating material.

4. The conductor terminal according to claim 1, wherein the casing made of insulating material has a second cover part at which at least one part of the first spring-loaded clamping connection is supported and/or fastened.

5. The conductor terminal according to claim 4, wherein the second cover part is insertable into the main casing part in a direction that runs at least substantially transversely to the conductor insertion direction of the first spring-loaded clamping connection.

6. The conductor terminal according to claim 1, wherein the first cover part is insertable into the main casing part in a direction that runs substantially parallel to the conductor insertion direction of the first spring-loaded clamping connection.

7. The conductor terminal according to claim 1, wherein the busbar extends through an opening from the first conductor-receiving space to the second conductor-receiving space, which is formed by opposite end faces of a wall of the main casing part and of the first cover part.

8. The conductor terminal according to claim 1, wherein the first spring-loaded clamping connection has a first clamping spring to clamp the first electrical conductor via a spring force, wherein the first clamping spring has a first clamping leg to clamp the first electrical conductor to a first clamping point arranged in the casing made of insulating material and the first contact leg, via which the first clamping spring is supported against the clamping force of the first clamping leg.

9. The conductor terminal according to claim 8, wherein the second spring-loaded clamping connection is arranged on the side of the first clamping leg, said side facing away from the first contact leg.

10. The conductor terminal according to claim 8, wherein the busbar has a first clamping section which forms the first clamping point with the first clamping leg.

11. The conductor terminal according to claim 10, wherein the busbar has a curved section, which adjoins the first clamping section and in which the busbar merges in an arcuate manner directly or via at least one further section of the busbar into a second clamping section, which forms a second clamping point with a second clamping leg of the second clamping spring for clamping the second electrical conductor.

12. The conductor terminal according to claim 11, wherein the second clamping section is arranged substantially and/or predominantly parallel to the first clamping section.

13. The conductor terminal according to claim 1, wherein the conductor terminal has an actuation element as a further component or an actuation lever or a push button, with which the first clamping leg is deflected by manual actuation in order to open the first clamping point.

14. The conductor terminal according to claim 1, wherein the casing made of insulating material has a first conductor insertion opening for inserting the first electrical conductor and a second conductor insertion opening for inserting the second electrical conductor, and wherein the first conductor insertion opening is arranged on a side of the conductor connection terminal, said side facing away from the second conductor insertion opening.
